(19) United States
(12) Patent Application Publication
(10) Pub. No.: US 2009/0075140 A1
(43) Pub. Date: Mar. 19, 2009

(54) ELECTRODE STRUCTURE OF FUEL CELL

(75) Inventors: Keiji Hashimoto, Nagakute-cho (JP); Eiichirou Morozumi, Nagakute-cho (JP); Michi Hashiba, Mizunami-shi (JP)

Correspondence Address: ROSSI, KIMMS & McDOWELL LLP., 20609 Gordon Park Square, Suite 150, Ashburn, VA, 20147, US

(73) Assignee: TOYOTA SHATAI KABUSHIKI KAISHA, Aichi-ken (JP)

(21) Appl. No.: 11/575,070

(22) PCT Filed: Jul. 20, 2006
(86) PCT No.: PCT/JP2006/314822

§ 371 Date: Mar. 11, 2007

(30) Foreign Application Priority Data
Sep. 5, 2005 (JP) 2005-256633
Sep. 5, 2005 (JP) 2005-256715

(51) Int. Cl. H01M 4/90

(52) U.S. Cl. 429/30

(57) ABSTRACT

An MEA includes an electrolyte membrane permeable to hydroxide ions. A catalyst layer formed of a hydrogen storage alloy is provided on one surface of the membrane facing the anode electrode layer. Another catalyst layer formed of platinum-on carbon is provided on the opposite surface of the membrane facing the cathode electrode layer. The catalyst layer on the anode-electrode-layer side dissociates hydrogen gas into atomic hydrogen, diffuses the atomic hydrogen by way of solid phase diffusion, and absorbs/desorbs atomic hydrogen. The catalyst layer on the cathode-electrode-layer side forms hydroxide ions from air, humidifying water, and electrons. The membrane allows movement of the hydroxide ions to the catalyst layer on the anode-electrode-layer side. This leads to formation of water on the anode-electrode-layer side, whereby occurrence of dry-up can be prevented. Even when flooding arises from formed water, atomic hydrogen can smoothly move through solid-phase diffusion. An open circuit voltage of the catalyst layer on the cathode-electrode-layer side can be made smaller than an elution potential of platinum. Since the catalyst layer on the anode-electrode-layer side absorbs excess hydrogen gas, wasteful discharge of hydrogen gas can be avoided.

### TECHNICAL FIELD

The present invention relates to a fuel cell, and particularly to the structure of an electrode employed in a polymer electrolyte fuel cell (or proton exchange membrane (PEM) type fuel cell).

### BACKGROUND ART

A polymer electrolyte fuel cell includes a membrane-electrode assembly (MEA) having an electrolyte membrane formed of an ion exchange membrane which is selectively permeable to cations (specifically hydrogen ions); an anode electrode layer including a catalyst layer and a gas diffusion layer and disposed on one surface of the electrolyte membrane where fuel gas (e.g., hydrogen gas) is introduced; and a cathode electrode layer including a catalyst layer and a gas diffusion layer and disposed on the opposite surface of the electrolyte membrane where oxidizer gas (e.g., air) is introduced.

When fuel gas and oxidizer gas (hereinafter may be collectively called gas) are supplied to a polymer electrolyte fuel cell of this kind, reactions represented by the following Reaction Formulas 1 and 2 occur in the anode electrode layer and the cathode electrode layer, respectively. Specifically, in the anode electrode layer, a reaction of dissociating hydrogen gas into hydrogen ions and electrons occurs, and dissociated hydrogen ions (i.e., cations) move through the electrolyte membrane toward the cathode electrode layer. On the cathode electrode layer, a reaction of forming water from oxygen contained in air, hydrogen ions, and electrons occurs.

Anode electrode layer:

H₂→2H⁺+2e⁻ Reaction Formula 1

Cathode electrode layer:

2H⁺+2e⁻+(½)O₂→H₂O Reaction Formula 2

Through the above reactions, the polymer electrolyte fuel cell supplies generated electricity to the exterior thereof.

Hydrogen ions formed through dissociation in the anode electrode layer move, together with water, through the electrolyte membrane toward the cathode electrode layer. In other words, hydrogen ions move from the anode electrode layer to the cathode electrode layer through hydration with water retained in the electrolyte membrane. Accordingly, as the above reactions progress, the water content of the electrolyte membrane lowers in the anode electrode layer.

In a state where the water content of the electrolyte membrane is lowered (in a so-called dry-up state), water required for movement of hydrogen ions becomes insufficient. As a result, electric resistance associated with permeation of hydrogen ions through the electrolyte membrane increases, possibly resulting in a drop in efficiency in the fuel cell generating electricity. Generally, in order to avoid a dry-up state of the electrolyte membrane, for example, a humidifier is provided separately for mixing hydrogen gas with humidifying water (water vapor), and the thus-humidified hydrogen gas is supplied to the anode electrode layer.

The operating temperature of the polymer electrolyte fuel cell is usually set to about 80° C. Accordingly, the peripheral temperature of the MEA varies from a temperature substantially equal to the outside air temperature to an operating temperature. In a state where the peripheral temperature of the MEA varies, the saturated vapor pressure of water vapor (humidifying water) supplied together with hydrogen gas varies accordingly. Thus, a large amount of water (excess water) may be condensed in the vicinity of the anode electrode layer. In this case, the water content of the polymer electrolyte membrane increases on the anode electrode layer, but there arises a problematic state where excess water is deposited on to the anode electrode layer (a so-called flooding state).

Occurrence of a flooding state hinders supply of hydrogen gas to a catalyst layer which partially constitutes the anode electrode layer. Specifically, since hydrogen gas moves, by way of gaseous phase diffusion, through pores which are formed in the catalyst layer and serve as passageways, occurrence of a flooding state on the anode electrode layer causes a blockade of the pores, thereby hindering supply of hydrogen gas. As a result, the reaction of dissociation in the anode electrode layer declines, resulting in a drop in hydrogen ions and electrons which move toward the cathode electrode layer. Accordingly, occurrence of a flooding state on the anode electrode layer also possibly causes a drop in efficiency in the fuel cell generating electricity. As can be understood from the above, it is important for the polymer electrolyte fuel cell to maintain an appropriate water content of the MEA; particularly, that of the electrolyte membrane.

In order to cope with the above problem, for example, Japanese Patent Application Laid-Open (kokai) No. 2004-158387 discloses an electrode structure for a polymer electrolyte fuel cell which can maintain an appropriate water content of an electrolyte membrane. In the conventional electrode structure, each of an anode electrode layer and a cathode electrode layer is composed of an electrode catalyst layer (catalyst layer) which includes pore-forming material for enhancing water drainage, and a gas diffusion layer on which a water retention layer is formed for enhancing water retentivity. Furthermore, in order to drain excess water of the gas diffusion layer, a water-repellent layer is provided between the water retention layer and the gas diffusion layer.

In the thus-configured electrode structure, the electrode catalyst layers (catalyst layers) exhibit enhanced water drainage, thereby suppressing occurrence of a flooding state at the cathode electrode layer which could otherwise result from formation of water associated with the above-mentioned reaction, as well as occurrence of a flooding state at the anode electrode layer which could otherwise result from excess water. Also, since the gas diffusion layers each have the water retention layer, occurrence of a dry-up state in the electrolyte membrane can be suppressed. Furthermore, since provision of the water-repellent layers enables drainage of excess water formed in the gas diffusion layers, gas can be favorably supplied from the gas diffusion layers to the corresponding electrode catalyst layers (catalyst layers), and the water retention layers can maintain appropriate water retentivity.

As is apparent from the above-mentioned Reaction Formulas 1 and 2, the polymer electrolyte fuel cell generates electricity through consumption of hydrogen gas, which serves as fuel gas. Accordingly, in a state where the polymer electrolyte fuel cell is not generating electricity, the polymer electrolyte fuel cell does not consume hydrogen gas, so that hydrogen gas stagnant on the anode-electrode-layer side must be retained safely. In a state where hydrogen gas is stagnant on the anode-electrode-layer side, for example, if air (more specifically, oxygen gas) permeates through the electrolyte membrane from the cathode electrode layer to the anode electrode layer, acute oxidation occurs, possibly deteriorating the electrolyte membrane and the catalyst layer.

In order to cope with the above problem, for example, Japanese Patent Application Laid-Open (kokai) No. 2004-362915 discloses a polymer electrolyte fuel cell which promptly discharges hydrogen gas present on the anode-electrode-layer side in a state of not generating electricity. This polymer electrolyte fuel cell includes an oxygen separation membrane for separating oxygen gas molecules from nitrogen gas molecules. When operation of the fuel cell is stopped, nitrogen gas separated by means of the oxygen separation membrane is introduced to the anode electrode layer, thereby discharging stagnant hydrogen gas.

### DISCLOSURE OF THE INVENTION

However, for example, in a state where the peripheral temperature of the MEA varies as mentioned above, the conventional electrode structure disclosed in the above-mentioned Japanese Patent Application Laid-Open (kokai) No. 2004-158387 possibly fails to completely discharge a large amount of formed excess water, so that a flooding state may arise. In the conventional electrode structure, externally introduced hydrogen gas and air diffuse in gaseous phase (i.e., gaseous phase diffusion) through the electrode catalyst layers (catalyst layers). Accordingly, when occurrence of a flooding state causes a blockade of pores, efficiency in the fuel cell generating electricity possibly drops. Particularly, enhancement of drainage of the electrode catalyst layer (catalyst layer) on the anode-electrode-layer side possibly drains even water which diffuses reversely from the cathode electrode layer to the anode electrode layer. Thus, even though the water retention layer is provided, occurrence of a dry-up state is possibly promoted.

In the conventional polymer electrolyte fuel cell disclosed in the above-mentioned Japanese Patent Application Laid-Open (kokai) No. 2004-362915, when operation is stopped, unreacted hydrogen gas is discharged to the exterior of the fuel cell; thus, hydrogen gas is wastefully discharged. Therefore, for example, in the case where start and stop are repeated, efficiency in generation of electricity significantly drops. When operation is stopped, the fuel cell requires time for discharging hydrogen gas through replacement with nitrogen gas; and, when operation is started, the fuel cell requires time for discharging nitrogen gas for introduction of hydrogen gas. Thus, generation of electricity cannot be started and stopped promptly, possibly impairing convenience. Since complete replacement of hydrogen gas with nitrogen gas is difficult, particularly, deterioration of the catalyst layer (e.g., elution of noble-metal catalyst added to the catalyst layer) may fail to be suppressed.

The present invention has been achieved for solving the above problems, and an object of the invention is to provide an electrode structure for a fuel cell in which a drop in efficiency in the fuel cell generating electricity, which could otherwise result from occurrence of a flooding state or occurrence of a dry-up state, is suppressed and in which deterioration of electrode material is suppressed, as well as in which supplied hydrogen gas can be consumed efficiently.

To achieve the above object, according to a feature of the present invention, an electrode structure for a fuel cell generating electricity through reaction between externally supplied fuel gas and oxidizer gas comprises an electrolyte membrane selectively permeable to specific ions; an anode electrode layer formed on one surface of the electrolyte membrane, dissociating molecular hydrogen contained in externally introduced fuel gas into atomic hydrogen and electrons, and allowing solid-phase diffusion of dissociated atomic hydrogen toward the electrolyte membrane; and a cathode electrode layer formed on the other surface of the electrolyte membrane and causing reaction between molecular oxygen contained in externally introduced oxidizer gas and electrons formed through dissociation effected by the anode electrode layer. In this case, preferably, the anode electrode layer contains, as a main component, for example, a hydrogen storage alloy which absorbs and desorbs atomic hydrogen.

Since the anode electrode layer can contain, as a main component, for example, a hydrogen storage alloy, the anode electrode layer can dissociate externally supplied molecular hydrogen (more specifically, hydrogen gas) into atomic hydrogen (more specifically, hydrogen ions) and electrons. The anode electrode layer allows dissociated atomic hydrogen to move toward the electrolyte membrane through solid-phase diffusion.

Thus, even when a flooding state occurs on the anode electrode layer as a result of, for example, supply of fuel gas together with humidifying water for avoiding occurrence of a dry-up state on the anode-electrode-layer side, atomic hydrogen can be dissociated efficiently from the externally supplied fuel gas and can move reliably toward the electrolyte membrane. Accordingly, regardless of occurrence of a flooding state, a drop in efficiency in the fuel cell generating electricity can be prevented. Furthermore, since the anode electrode layer can be formed from a hydrogen storage alloy, there is no need to employ expensive platinum as in the case of the conventional electrode structure. Therefore, the cost of manufacturing the fuel cell can be greatly reduced.

According to another feature of the present invention, metal oxide particles having hydrophilicity are added to the anode electrode layer. In this case, preferably, the metal oxide particles are, for example, oxide particles of at least one metal selected from the group consisting of titanium, silicon, aluminum, chromium, magnesium, and zirconium. Addition of metal oxide particles having hydrophilicity to the anode electrode layer imparts good hydrophilicity to the anode electrode layer, whereby the anode electrode layer can retain water efficiently.

Dispersing the added metal oxide particles in the anode electrode layer imparts far better hydrophilicity to the anode electrode layer. By practicing this, when formed water diffuses reversely from the cathode electrode layer to the anode electrode layer, the metal oxide particles dispersed in the anode electrode layer can also efficiently absorb and retain reversely diffused water.

By means of efficient water retention of the anode electrode layer, the electrolyte membrane can maintain a good water content. Accordingly, for example, even when only hydrogen gas is supplied; i.e., hydrogen gas is supplied without being mixed with humidifying water, occurrence of a dry-up state on the anode-electrode-layer side can be suppressed, whereby the fuel cell can maintain good efficiency in generation of electricity.

Since the electrolyte membrane can maintain a good water content, deterioration of the electrolyte membrane (e.g., breakage of the electrolyte membrane) associated with occurrence of a dry-up state can be suppressed, whereby durability of the electrolyte membrane can be improved. Furthermore, since the fuel cell can be operated without need to supply humidifying water (so-called nonhumidification operation), a humidifier can be eliminated from a fuel cell system, thereby freeing the fuel cell system from troublesome humidification management.

According to still another feature of the present invention, the oxidizer gas, together with humidifying water, is introduced into the cathode electrode layer; and the electrolyte membrane is selectively permeable to hydroxide ions formed through reaction in the cathode electrode layer among the molecular oxygen, the humidifying water, and the electrons.

According to this feature, when electrons formed through dissociation effected by the anode electrode layer are supplied to the cathode electrode layer via, for example, an external circuit, the cathode electrode layer forms hydroxide ions through reaction among oxygen contained in oxidizer gas, humidifying water, and the supplied electrons. The electrolyte membrane selectively allows the formed hydroxide ions to permeate therethrough to the anode electrode layer. Accordingly, in the anode electrode layer, there arises a reaction of forming water from dissociated atomic hydrogen which is diffused by way of solid phase diffusion, and hydroxide ions which are supplied via the electrolyte membrane.

By virtue of humidifying water supplied to the cathode electrode layer and water formed on the anode-electrode-layer side, the electrolyte membrane maintains a very good water content, thereby preventing occurrence of a dry-up state. In this case, since the anode electrode layer allows atomic hydrogen to move toward the electrolyte membrane through solid-phase diffusion, a decline in reaction which could otherwise accompany occurrence of a flooding state does not arise.

The cathode electrode layer forms hydroxide ions from humidifying water. Thus, for example, even when humidifying water is supplied excessively, the reaction consumes humidifying water, thereby preventing occurrence of a flooding state on the cathode electrode layer. Therefore, there can be prevented a drop in efficiency in the fuel cell generating electricity which could otherwise accompany occurrence of a flooding state or occurrence of a dry-up state.

According to a further feature of the present invention, the anode electrode layer is formed from a hydrogen storage alloy for suppressing an increase in open circuit voltage on the cathode-electrode-layer side. In this case, preferably, the hydrogen storage alloy used to form the anode electrode layer has a property of desorbing absorbed atomic hydrogen when a peripheral temperature of the anode electrode layer falls within a predetermined operating-temperature range of the fuel cell, and absorbing atomic hydrogen when a peripheral temperature of the anode electrode layer is in the vicinity of room temperature. Furthermore, preferably, the hydrogen storage alloy is an alloy having at least one composition selected from the group consisting of, for example, LaNi_{4.5}Al_{0.5}, LaNi_{4.7}Al_{0.3}, and Ti_{1.1}Fe_{0.8}Ni_{0.1}Zr_{0.05}.

According to the above features of the present invention, the anode electrode layer can contain, as a main component, a hydrogen storage alloy selected from among LaNi_{4.5}Al_{0.5}, LaNi_{4.7}Al_{0.3}, and Ti_{1.1}Fe_{0.8}Ni_{0.1}Zr_{0.05}. These hydrogen storage alloys can dissociate externally supplied fuel gas; for example, molecular hydrogen (more specifically, hydrogen gas), into atomic hydrogen (more specifically, hydrogen ions) and electrons and can absorb (store) dissociated atomic hydrogen and, as needed, desorb molecular hydrogen. Thus, the anode electrode layer can desorb hydrogen gas required for a reaction on the anode-electrode-layer side in the operating-temperature range of the fuel cell and can absorb (store) hydrogen gas which is supplied to the anode electrode layer and remains unreacted at a temperature in the vicinity of room temperature.

Thus, hydrogen gas can be retained safely, whereby supplied hydrogen gas is not discharged wastefully and can be consumed effectively. Particularly, when the fuel cell is suspended, there is no need to replace hydrogen gas on the anode-electrode-layer side with, for example, nitrogen gas, thereby allowing prompt starting and stopping of electricity generation. Therefore, the fuel cell can provide improved convenience.

Generally, in the fuel cell in a no-load state, an open circuit voltage is generated on each of the anode-electrode-layer side and the cathode-electrode-layer side. In a state where such open circuit voltages are generated, for example, inflow of oxidizer gas (e.g., oxygen gas) from the cathode electrode layer to the anode electrode layer may cause formation of a mixed potential on the anode-electrode-layer side as a result of reaction between hydrogen gas (more specifically, hydrogen ions) and oxygen gas. Formation of a mixed potential on the anode-electrode-layer side may cause the open circuit voltage of the cathode electrode layer to locally rise in relation to the mixed potential. Since a rising open circuit voltage of the cathode electrode layer exceeds an elution potential at which noble metal (e.g., platinum) which is added as catalyst to the catalyst layer is eluted, elution of the noble metal is accelerated, resulting in a rapid deterioration in the catalyst layer.

By contrast, by means of forming the anode electrode layer from a hydrogen storage alloy, the anode electrode layer can absorb (store) unreacted hydrogen gas, thereby preventing formation of a mixed potential on the anode-electrode-layer side. Thus, an increase in the open circuit voltage of the cathode electrode layer can be suppressed, whereby elution of noble metal can be suppressed. Therefore, deterioration in the catalyst layer of the cathode electrode layer can be suppressed.

In the case where the electrolyte membrane is formed of an ion exchange membrane which is selectively permeable to hydroxide ions; i.e., anions, the electrolyte membrane allows permeation of anions formed on the cathode-electrode-layer side to the anode-electrode-layer side. Since this lowers the open circuit voltage of the cathode electrode layer below the elution potential, elution of noble metal from the cathode electrode layer can be suppressed effectively. Therefore, deterioration in the catalyst layer can be prevented.

### BRIEF DESCRIPTION OF THE DRAWINGS

FIG. 1 is a sectional view showing a schematic structure of a single cell according to an embodiment of the present invention;

FIG. 2 is an equilibrium dissociation pressure vs. temperature diagram for hydrogen storage alloys that can be used to form a catalyst layer which serves as an anode electrode layer;

FIG. 3 is a view for explaining movement of atomic hydrogen in a catalyst layer of FIG. 1 that is adjacent to the anode electrode layer;

FIG. 4 is a pair of views for explaining a state of pressure on the anode-electrode-layer side and the cathode-electrode-layer side, wherein A shows a state of pressure, in an active state, on the anode-electrode-layer side and the cathode-electrode-layer side, and B shows a state of pressure, in an inactive state, on the anode-electrode-layer side and the cathode-electrode-layer side;

FIG. 5 is a sectional view schematically showing a comparative structure of a single cell for explaining elution of platinum (Pt) from a catalyst layer of a cathode electrode layer;

FIG. 6 is a view for explaining electrode potentials associated with reactions which occur in the anode electrode layer and the cathode electrode layer;

FIG. 7 is a pair of views for explaining elution of platinum (Pt) in the comparative structure;

FIG. 8 is a pair of views for explaining suppression of elution of platinum (Pt) in an electrode structure according to the embodiment of the present invention; and

FIG. 9 is a sectional view showing a schematic structure of a single cell according to a modified embodiment of the present invention.

### BEST MODE FOR CARRYING OUT THE INVENTION

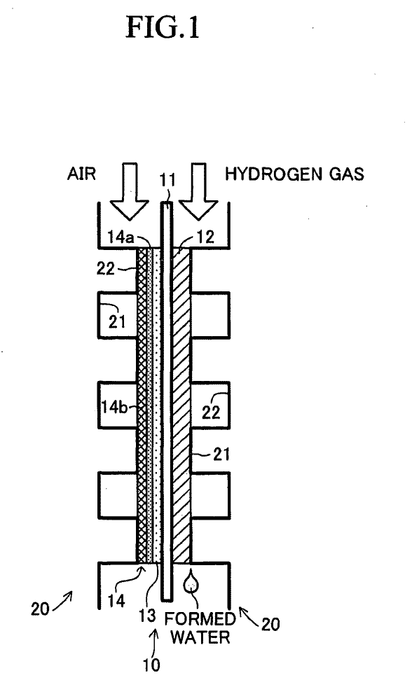

An embodiment of the present invention will next be described in detail with reference to the drawings. FIG. 1 schematically shows major portions of a single cell of a fuel cell which employs an electrode structure according to the present invention. The single cell includes an MEA 10, separators 20 for supplying externally introduced gas to the MEA 10, and an unillustrated resin frame (gasket).

The MEA 10 includes an electrolyte membrane 11 which is formed of an ion exchange membrane. The electrolyte membrane 11 is formed of an ion exchange membrane (e.g., NEOCEPTOR (registered trademark of a product of Tokuyama)) which is selectively permeable to anions (more specifically, hydroxide ions (OH⁻)). A catalyst layer 12 is formed on one surface of the electrolyte membrane 11 to which fuel gas (e.g., hydrogen gas) is introduced; i.e., on the anode-electrode-layer side. A catalyst layer 13 and a gas diffusion layer 14 are formed on the opposite surface of the electrolyte membrane 11 to which oxidizer gas (e.g., air) is introduced; i.e., on the cathode-electrode-layer side.

The catalyst layer 12, which serves as an anode electrode layer, dissociates supplied molecular hydrogen; i.e., hydrogen gas, into atomic hydrogen (hydrogen ions (H⁺)) and electrons, and causes dissociated atomic hydrogen to undergo solid-phase diffusion toward the electrolyte membrane 11. Thus, the catalyst layer 12 contains, as a main component, a hydrogen storage alloy.

A hydrogen storage alloy used to form the catalyst layer 12 is selected as appropriate from among hydrogen storage alloys having the following crystal structures. That is, applicable hydrogen storage alloys include AB₅-type hydrogen storage alloys, typified by LaNi₅; AB₂-type (Laves-phase-type) hydrogen storage alloys, typified by ZnMn₂ or its substitution product; A₂B-type hydrogen storage alloys, typified by Mg₂Ni or its substitution product; solid-solution-type V-based hydrogen storage alloys; and Ti—Fe hydrogen storage alloys.

These hydrogen storage alloys have a relatively large interatomic distance (i.e., a relatively large lattice spacing) in terms of formation of crystal and thus exhibit crystal structures having a relatively large number of pores. Thus, these hydrogen storage alloys allow solid-phase diffusion of dissociated atomic hydrogen through pores in their crystal structures and are likely to absorb (store) dissociated atomic hydrogen in the pores. A hydrogen storage alloy is selected in consideration of, for example, an operating temperature of the fuel cell and a required electricity generation capacity of the fuel cell. The selection of a hydrogen storage alloy will next be described specifically.

Generally, when the fuel cell is in a state of generating electricity (i.e., in an active state), the internal temperature of a fuel cell stack is maintained at around 80° C., for example, by means of operation of an unillustrated cooling system. When the fuel cell is in a state of not generating electricity (i.e., in an inactive state), the internal temperature of the fuel cell stack becomes room temperature (e.g., around 25° C.).

Thus, a hydrogen storage alloy used to form the catalyst layer 12 must have a property of readily desorbing atomic hydrogen when the peripheral temperature of the MEA 10 becomes around 80° C. (hereinafter called a high-peripheral-temperature range) in an active state. Also, the hydrogen storage alloy must have a property of readily absorbing atomic hydrogen when the peripheral temperature of the MEA 10 becomes around 25° C. (hereinafter called a low-peripheral-temperature range) in an inactive state, in order to safely retain hydrogen gas.

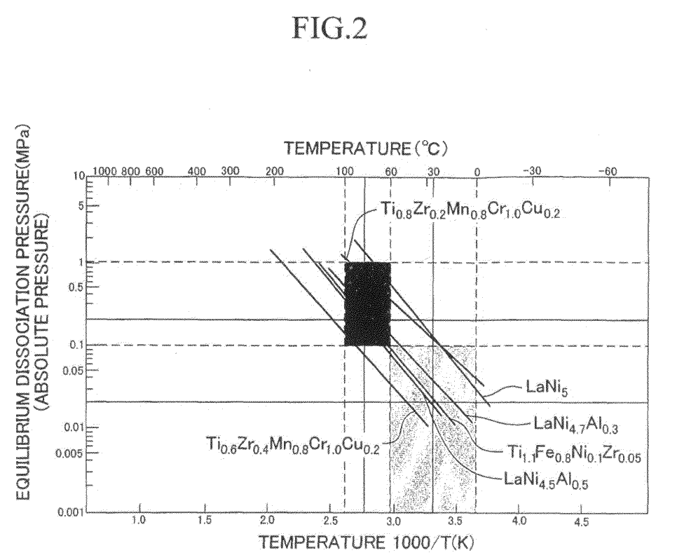

Hydrogen storage alloys which satisfy the above requirements include, particularly, the above-mentioned AB₅-type hydrogen storage alloys, AB₂-type (Laves-phase-type) hydrogen storage alloys, and Ti—Fe hydrogen storage alloys. FIG. 2 shows an equilibrium dissociation pressure vs. temperature diagram (P-T diagram) for these hydrogen storage alloys having their typical compositions. Specifically, the P-T diagram of FIG. 2 shows the relationship between temperature and equilibrium dissociation pressure for LaNi₅, LaNi_{4.5}Al_{0.5}, and LaNi_{4.7}Al_{0.3}, which are AB₅-type hydrogen storage alloys; Ti_{0.8}Zr_{0.2}Mn_{0.8}Cr_{1.0}Cu_{0.2} and Ti_{0.6}Zr_{0.4}Mn_{0.8}Cr_{1.0}Cu_{0.2}, which are AB₂-type hydrogen storage alloys; and Ti_{1.1}Fe_{0.8}Ni_{0.1}Zr_{0.5}, which is a Ti—Fe hydrogen storage alloy.

As is apparent from the P-T diagram, hydrogen storage alloys which readily desorb atomic hydrogen in the high-peripheral-temperature range (i.e., in an active state) as shown by the dark matt area (densely dotted area); in other words, hydrogen storage alloys whose equilibrium dissociation pressures in the high-peripheral-temperature range are greater than the atmospheric pressure 0.1 MPa, are AB₅-type hydrogen storage alloys of LaNi₅, LaNi_{4.5}Al_{0.5}, and LaNi_{4.7}Al_{0.3}; an AB₂-type hydrogen storage alloy of Ti_{0.8}Zr_{0.2}Mn_{0.8}Cr_{1.0}Cu_{0.2}; and a Ti—Fe hydrogen storage alloy of Ti_{1.1}Fe_{0.8}Ni_{0.1}Zr_{0.05}. Notably, hydrogen storage alloys desorb atomic hydrogen, strictly, in the form of molecular hydrogen.

Hydrogen storage alloys which readily absorb (store) atomic hydrogen in the low-peripheral-temperature range (i.e., in an inactive state) shown by the light matt area (lightly dotted area); in other words, hydrogen storage alloys whose equilibrium dissociation pressures in the low-peripheral-temperature range are lower than the atmospheric pressure 0.1 MPa, are AB₅-type hydrogen storage alloys of LaNi_{4.5}Al_{0.5} and LaNi_{4.7}Al_{0.3}; an AB₂-type hydrogen storage alloy of Ti_{0.6}Zr_{0.4}Mn_{0.8}Cr_{1.0}Cu_{0.2}; and a Ti—Fe hydrogen storage alloy of Ti_{1.1}Fe_{0.8}Ni_{0.1}Zr_{0.05}.

Hydrogen storage alloys which readily desorb and absorb (store) atomic hydrogen in both of the high-peripheral-temperature range and the low-peripheral-temperature range are AB₅-type hydrogen storage alloys of LaNi_{4.5}Al_{0.5} and LaNi_{4.7}Al_{0.3} and a Ti—Fe hydrogen storage alloy of Ti_{1.1}Fe_{0.8}Ni_{0.1}Zr_{0.05}. Accordingly, these three hydrogen storage alloys satisfy the requirements for application to formation of the catalyst layer 12. Therefore, a hydrogen storage alloy having at least one compositions of these three hydrogen storage alloys is selected and used to form the catalyst layer 12.

More preferably, among these three hydrogen storage alloys, LaNi_{4.5}Al_{0.5} or Ti_{1.1}Fe_{0.8}Ni_{0.1}Zr_{0.05}, whose equilibrium dissociation pressures vary in the high-peripheral-temperature range and the low-peripheral-temperature range shown by matt areas in FIG. 2, is selected and used to form the catalyst layer 12. Most preferably, of these two hydrogen storage alloys, LaNi_{4.5}Al_{0.5}, whose equilibrium dissociation pressure is lower in the low-peripheral-temperature range, is selected and used to form the catalyst layer 12. The following description assumes that the catalyst layer 12 is formed from a hydrogen storage alloy of LaNi_{4.5}Al_{0.5}. Needless to say, even when Ti_{1.1}Fe_{0.8}Ni_{0.1}Zr_{0.05} or LaNi_{4.7}Al_{0.3} is selected and used to form the catalyst layer 12, actions and effects similar to those appearing in the following description will be yielded.

In formation of the catalyst layer 12, an alloy which is selected as appropriate from among these hydrogen storage alloys; i.e., LaNi_{4.5}Al_{0.5}, is powdered by use of, for example, a ball mill. To the LaNi_{4.5}Al_{0.5} powder are added, for example, isopropyl alcohol and a predetermined binder (e.g., a binder which contains an anion exchange resin as a main component). The resultant mixture is stirred. After the stirred mixture is applied to one surface of the electrolyte membrane 11, the electrolyte membrane 11 and the applied mixture are subjected to, for example, hot pressing for joining, thereby forming the catalyst layer 12.

In place of the above formation of the catalyst layer 12 in which the mixture is applied to the electrolyte membrane 11, and the applied mixture and the electrolyte membrane 11 are subjected to pressing for joining, for example, the following procedure may be employed. The stirred mixture is rolled and dried into a sheet of the catalyst layer 12 which contains a hydrogen storage alloy as a main component. Then, the sheet and the electrolyte membrane 11 are joined. The hydrogen storage alloy powder can be formed into a sheet also by means of sintering.

A catalyst layer 13 of the cathode electrode layer is adapted to form hydroxide ions (anions) from molecular oxygen contained in supplied air; i.e., oxygen gas, humidifying water supplied with air, and electrons supplied from the anode electrode layer. The catalyst layer 13 contains, as a main component, carbon which carries noble-metal catalyst (e.g., platinum) (hereinafter the carbon is called carrier carbon).

Specifically, carrier carbon is dispersed in water. To the resultant dispersion liquid are added isopropyl alcohol and a binder (e.g., a binder which contains an anion exchange resin as a main component). The resultant mixture is stirred. After the stirred mixture liquid is applied to the other surface of the electrolyte membrane 11, the electrolyte membrane 11 and the applied mixture are subjected to, for example, hot pressing for joining, thereby forming the catalyst layer 13.

The gas diffusion layer 14 of the cathode electrode layer is air-permeable and is adapted to supply air flowing through the separator 20 to the catalyst layer 13 in a uniformly diffused manner. The gas diffusion layer 14 includes a water-repellent layer 14a and a matrix 14b. The water-repellent layer 14a is formed, for example, by bonding carbon particles with resin (e.g., poly-tetra fluoro ethylene (PTFE)). The matrix 14b is formed from, for example, carbon fiber. The gas diffusion layer 14 is held between the electrolyte membrane 11 and the separator 20 in such a manner that the water-repellent layer 14a and the catalyst layer 13 are superposed on each other.

The separators 20 have a function of supplying hydrogen gas and air introduced from the exterior of the fuel cell to the anode electrode layer and the cathode electrode layer, respectively, and a function of collecting electricity which is generated through reactions in the MEA 10. To carry out the functions, the separators 20 are formed of, for example, a stainless steel sheet. As shown in FIG. 1, a large number of streaky recess portions 21 and streaky projection portions 22 are formed on the stainless steel sheet. As shown in FIG. 1, the two separators 20 hold the MEA 10 therebetween.

In place of the stainless steel sheet, for example, a steel sheet which has undergone anticorrosive treatment such as gold plating or nickel plating may be used to form the separators 20. In place of metal, for example, an electrically conductive nonmetal material such as carbon may also be used to form the separators 20.

A plurality of cells each configured as described above are stacked in accordance with a required output of the fuel cell, thereby forming a fuel cell stack. When hydrogen gas and air are introduced to the fuel cell stack, chemical reactions (hereinafter called electrode reactions) occur in the anode electrode layer and the cathode electrode layer of the MEA 10 of each cell, thereby generating electricity. The electrode reactions will next be described.

First, electrode reaction in the anode electrode layer will be described. Hydrogen gas introduced from the exterior of the fuel cell is supplied to the catalyst layer 12 through the streaky projection portions 22 (or the streaky recess portions 21) of the separator 20. When supplied hydrogen gas (molecular hydrogen) contacts a hydrogen storage alloy used to form the catalyst layer 12; i.e., LaNi_{4.5}Al_{0.5}, molecular hydrogen is physically adsorbed onto the surface of LaNi_{4.5}Al_{0.5} by the effect of van der Waals forces. Molecular bond of the physically adsorbed molecular hydrogen is broken, for example, by the effect of surface energy of LaNi_{4.5}Al_{0.5}, thereby being dissociated into atomic hydrogen and electrons. Dissociated atomic hydrogen diffuses by way of solid phase diffusion, through the catalyst layer 12 (specifically, through inside of LaNi_{4.5}Al_{0.5} crystals) toward the electrolyte membrane 11. Dissociated electrons are supplied to the cathode electrode layer via an unillustrated external circuit.

Next, an electrode reaction in the cathode electrode layer will be described. Air containing humidifying water introduced from the exterior of the fuel cell is supplied to the gas diffusion layer 14 through the streaky recess portions 21 (or the streaky projection portions 22) of the separator 20. Air supplied to the gas diffusion layer 14 diffuses uniformly and is supplied toward the catalyst layer 13. When oxygen gas (i.e., molecular oxygen) contained in supplied air, and humidifying water contact the surface of platinum of carrier carbon used to form the catalyst layer 13, hydroxide ions are generated by the effect of electrons supplied from the anode electrode layer. The thus-formed hydroxide ions (i.e., anions) permeate through the electrolyte membrane 11 and move toward the anode-electrode-layer side.

Such movement of hydroxide ions causes formation of water on the anode-electrode-layer side by reaction between hydride ions and atomic hydrogen which undergoes solid-phase diffusion in the catalyst layer 12 (more specifically, hydrogen which is in a molecular form as a result of desorption from the catalyst layer 12). These electrode reactions are represented by the following Reaction Formulas 3 and 4.

Anode electrode layer:

H₂+2OH⁻→2H₂O+2e⁻ Reaction Formula 3

Cathode electrode layer:

(½)O₂+H₂O+2e⁻→2OH⁻ Reaction Formula 4

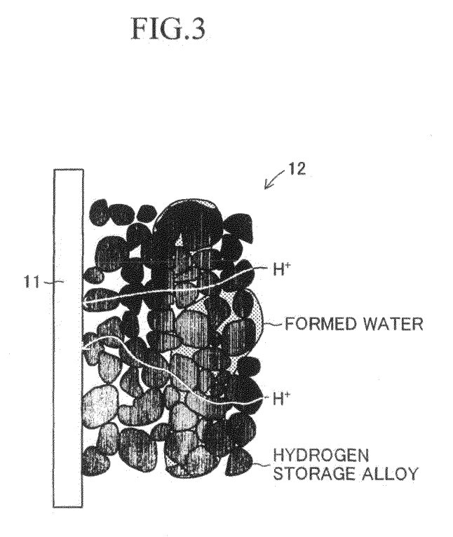

In the present embodiment, water is formed by the reaction on the anode-electrode-layer side. Thus, a large amount of water may be formed in the catalyst layer 12 of the anode electrode layer. However, since the catalyst layer 12 contains a hydrogen storage alloy (LaNi_{4.5}Al_{0.5}) as a main component, as shown in FIG. 3, dissociated atomic hydrogen (hydrogen ions) undergoes solid-phase diffusion through the crystal structure of a hydrogen storage alloy (LaNi_{4.5}Al_{0.5}). Therefore, even when a flooding state occurs in the catalyst layer 12, movement of atomic hydrogen is not hindered. Since water is formed on the anode-electrode-layer side, for example, even when unhumidified hydrogen gas is supplied to the anode electrode layer, occurrence of a dry-up state can be prevented.

Meanwhile, in order to prevent occurrence of a dry-up state, air, together with humidifying water, is supplied to the cathode electrode layer. Thus, a large amount of excess water may arise in the catalyst layer 13 and the gas diffusion layer 14 of the cathode electrode layer. However, since an electrode reaction in the cathode electrode layer uses water which is present in the vicinity of the catalyst layer 13, water is consumed with progress of reaction. Furthermore, since water repellency is imparted to the catalyst layer 13 and to the gas diffusion layer 14, excess water can be well drained. Accordingly, on the cathode-electrode-layer side, occurrence of a flooding state is suppressed; as a result, hydroxide ions (anions) can be well formed.

When the fuel cell is in an active state, the peripheral temperature of the MEA 10 changes from the low-peripheral-temperature range to the high-peripheral-temperature range. In a state where a peripheral temperature of the MEA 10 rises, as shown in FIG. 2, the equilibrium dissociation pressure of LaNi_{4.5}Al_{0.5} used to form the catalyst layer 12 increases. As the equilibrium dissociation pressure increases, LaNi_{4.5}Al_{0.5} begins desorbing atomic hydrogen which was absorbed (stored) in the low-peripheral-temperature range. This will next be described specifically.

Immediately after supply of hydrogen gas is started in association with transition from an inactive state to an active state (hereinafter called “immediately after start-up”), a peripheral temperature of the MEA 10 is in the low-peripheral-temperature range; thus, the equilibrium dissociation pressure of LaNi_{4.5}Al_{0.5} used to form the catalyst layer 12 is lower than the atmospheric pressure (0.1 MPa). Accordingly, immediately after start-up, LaNi_{4.5}Al_{0.5} absorbs (stores) atomic hydrogen dissociated from supplied hydrogen gas. Generally, a hydrogen storage alloy initiates an exothermic reaction when absorbing (storing) atomic hydrogen. Thus, LaNi_{4.5}Al_{0.5} which is absorbing (storing) atomic hydrogen generates heat, causing a rapid increase in peripheral temperature of the MEA 10.

As shown in FIG. 2, the equilibrium dissociation pressure of LaNi_{4.5}Al_{0.5} becomes equal to the atmospheric pressure at a temperature of about 60° C. and becomes greater than the atmospheric pressure at a temperature in excess of 60° C. That is, when a peripheral temperature of the MEA 10 exceeds about 60° C., LaNi_{4.5}Al_{0.5} readily desorbs absorbed (stored) atomic hydrogen. Thus, by means of promptly raising the peripheral temperature of the MEA 10 to 60° C. or higher through the exothermic reaction which is initiated immediately after start-up, LaNi_{4.5}Al_{0.5} can well desorb atomic hydrogen. Therefore, desorbed atomic hydrogen can be consumed, whereby Reaction Formula 3 can smoothly progress, and thus the fuel cell can exhibit good starting characteristics.

In the high-peripheral-temperature range, the equilibrium dissociation pressure of LaNi_{4.5}Al_{0.5} becomes higher than the atmospheric pressure; thus, LaNi_{4.5}Al_{0.5} is in a state of desorbing atomic hydrogen at all times. In this state, LaNi_{4.5}Al_{0.5} merely causes solid-phase diffusion of dissociated atomic hydrogen through crystals without absorbing (storing) dissociated atomic hydrogen within the crystals. Thus, in the high-peripheral-temperature range, atomic hydrogen which merely diffuses by way of solid phase diffusion within the crystal structure of LaNi_{4.5}Al_{0.5} becomes consumable, so that Reaction Formula 3 progresses smoothly. Accordingly, the fuel cell in an active state can stably supply electricity to the exterior thereof.

When supply of hydrogen gas and air is shut off, and the external circuit is opened, the fuel cell is brought to an inactive state. In this inactive state, a hydrogen storage alloy used to form the catalyst layer 12; i.e., LaNi_{4.5}Al_{0.5}, begins absorbing (storing) hydrogen gas present on the anode-electrode-layer side (hereinafter hydrogen gas which is present on the anode-electrode-layer side in an inactive state is called excess hydrogen gas). This will next be described specifically.

Immediately after supply of hydrogen gas is shut off in association with transition from an active state to an inactive state (hereinafter called “immediately after shutoff”), a peripheral temperature of the MEA 10 is in the high-peripheral-temperature range; thus, the equilibrium dissociation pressure of LaNi_{4.5}Al_{0.5} used to form the catalyst layer 12 is greater than the atmospheric pressure. Accordingly, immediately after shutoff, LaNi_{4.5}Al_{0.5} desorbs atomic hydrogen dissociated from supplied hydrogen gas. Generally, a hydrogen storage alloy initiates an endothermic reaction when desorbing atomic hydrogen. Thus, LaNi_{4.5}Al_{0.5} which is desorbing atomic hydrogen absorbs heat, causing a rapid drop in peripheral temperature of the MEA 10.

By means of promptly lowering a peripheral temperature of the MEA 10 to less than 60° C. through the endothermic reaction which is initiated immediately after shutoff, the equilibrium dissociation pressure of LaNi_{4.5}Al_{0.5} becomes lower than the atmospheric pressure and thus begins absorbing (storing) atomic hydrogen in contrast to the above-described desorption of atomic hydrogen. Then, for example, when the peripheral temperature of the MEA 10 is lowered further by use of a cooling system provided with the fuel cell, the equilibrium dissociation pressure of LaNi_{4.5}Al_{0.5} drops uniformly, so that LaNi_{4.5}Al_{0.5} can well absorb atomic hydrogen present on the anode-electrode-layer side. Therefore, when the fuel cell is in an inactive state, LaNi_{4.5}Al_{0.5} absorbs (stores) excess hydrogen gas, whereby excess hydrogen gas can be retained safely, and progress of Reaction Formula 3 can be suppressed.

Since excess hydrogen gas can be retained safely as mentioned above, there is no need to replace excess hydrogen gas with inert gas such as nitrogen gas, so that supplied hydrogen gas can be utilized effectively. Since an operation of replacement with inert gas becomes unnecessary, the amount of impurities; in other words, gas other than hydrogen gas, present in an atmosphere on the anode-electrode-layer side can be suppressed. Thus, for example, when the fuel cell is brought again into an active state, hindrance to reactions which could otherwise results from presence of impurities can be prevented, so that electrode reactions can promptly progress.

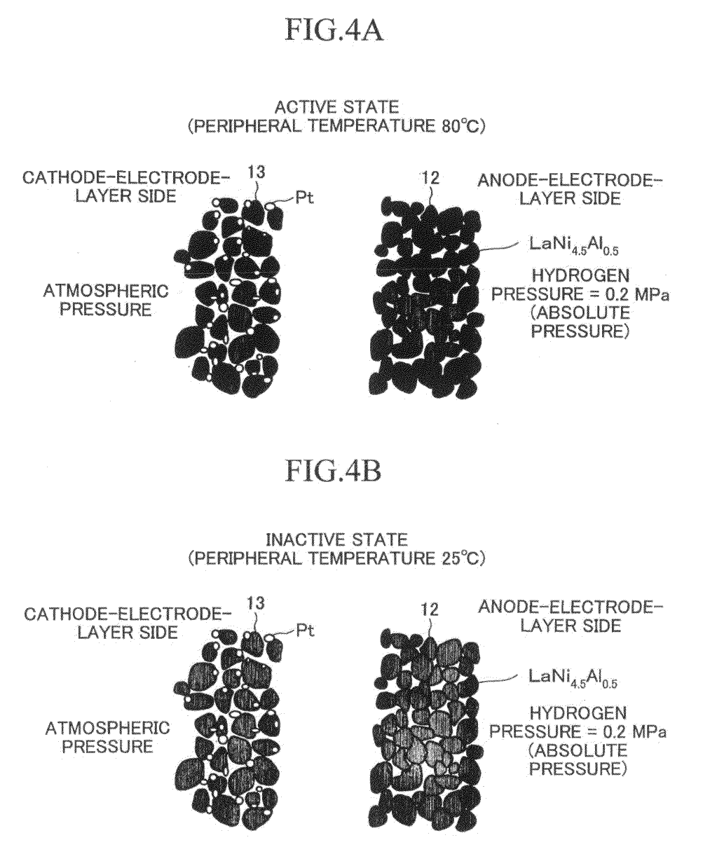

FIG. 4 schematically shows the above-mentioned states of pressure in a single cell in an active state and in an inactive state. Specifically, as shown in FIG. 4A, in an active state (peripheral temperature is around 80° C.), the pressure of hydrogen gas (hydrogen pressure) on the anode-electrode-layer side is about 0.2 MPa (absolute pressure) as a result of LaNi_{4.5}Al_{0.5} desorbing atomic hydrogen, whereas the cathode-electrode-layer side has a pressure of externally introduced air (atmospheric pressure). As shown in FIG. 4B in an inactive state (peripheral temperature is around 25° C.), hydrogen pressure on the anode-electrode-layer side is about 0.02 MPa (absolute pressure) as a result of LaNi_{4.5}Al_{0.5} absorbing (storing) atomic hydrogen, whereas the cathode-electrode-layer side has the atomic pressure.

Employment of the above-described structure of a single cell can effectively suppress elution of platinum (Pt) added to the catalyst layer 13 of the cathode electrode layer, particularly, in a state where no load is imposed on the fuel cell, and thus no current is flowing (hereinafter called a no-load state). This will next be described specifically.

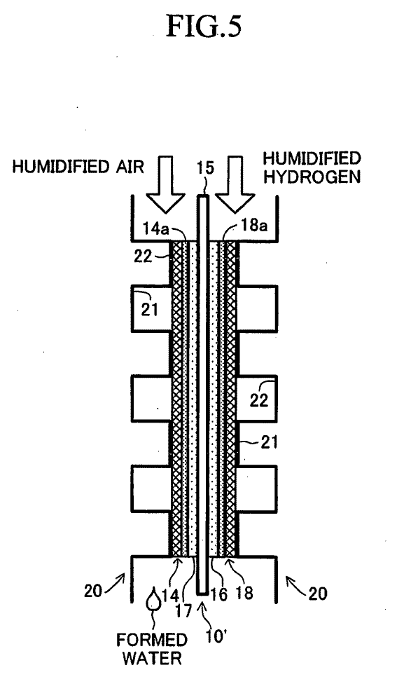

In order to facilitate understanding of suppression of elution of platinum (Pt) from the catalyst layer 13, a structure of a single cell in a conventionally wide use will be described as a comparative structure with reference to FIG. 5. As shown in FIG. 5, an MEA 10′ of the comparative structure of a single cell includes an electrolyte membrane 15 formed of an ion exchange membrane (e.g., NAFION (registered trademark of a product of Du Pont)) which is selectively permeable to cations (more specifically, hydrogen ions (H⁺)).

In the MEA 10′, the cathode-electrode-layer and the anode-electrode-layer of the electrolyte membrane 15 have the same structure and are formed in the following manner. A catalyst layer 16 on the anode-electrode-layer side and a catalyst layer 17 on the cathode-electrode-layer side are formed as follows. First, carrier carbon is dispersed in water. To the resultant dispersion liquid are added isopropyl alcohol, PTFE, and a binder formed of a cation exchange resin (e.g., NAFION (registered trademark) solution). The resultant mixture is kneaded. The kneaded mixture is applied to water-repellent layers 14a and 18a of gas diffusion layers 14 and 18. Subsequently, the gas diffusion layers 14 and 18 are superposed on the electrolyte membrane 15 in such a manner that the electrolyte membrane 15 faces the water-repellent layers 14a and 18a. Then, the resultant laminate is subjected to, for example, hot-pressing, thereby yielding an assembly of the electrolyte membrane 15 and the catalyst layers 16 and 17. The gas diffusion layer 18 is formed in a manner similar to that of the above-described formation of the gas diffusion layer 14 of the cathode electrode layer.

When a fuel cell having the above-described comparative structure is brought into an active state, and hydrogen gas and oxidizer gas are supplied, the electrode reactions of Reaction Formulas 1 and 2 occur on the anode-electrode-layer side and the cathode-electrode-layer side, respectively. Specifically, in the catalyst layer 16 of the anode electrode layer, a reaction of dissociating supplied hydrogen gas into hydrogen ions and electrons occurs. Dissociated hydrogen ions (i.e., cations) move through the electrolyte membrane 15 toward the cathode electrode layer. In the catalyst layer 17 of the cathode electrode layer, a reaction of forming water from oxygen gas contained in air, hydrogen ions, and electrons occurs.

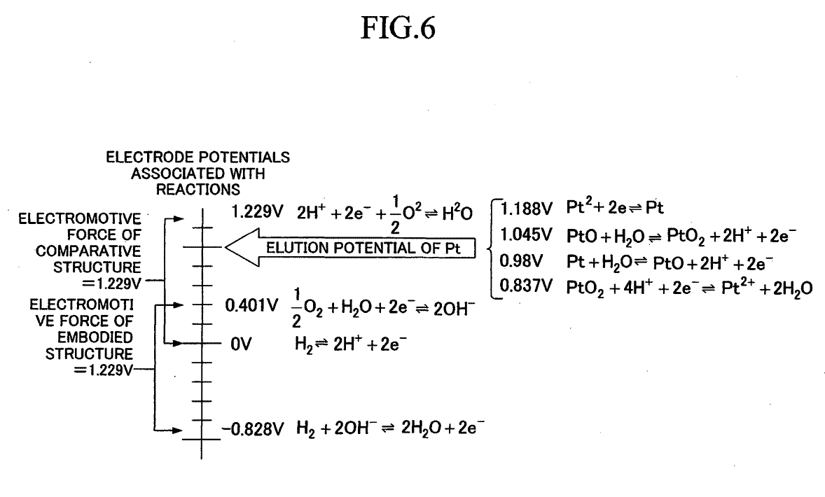

Next will be described, with reference to FIG. 6, conditions of elution of platinum (Pt) from the catalyst layer 16 of the anode electrode layer and from the catalyst layer 17 of the cathode electrode layer in a no-load state of the fuel cell which employs the comparative structure. Platinum (Pt) has various elution potentials according to modes of elution. As shown in FIG. 6, when platinum (Pt) is eluted, it has an elution potential of 0.837 V to 1.188 V. In other words, when a potential (voltage) higher than this elution potential is present on the cathode-electrode-layer side or on the anode-electrode-layer side, platinum (Pt) is readily eluted.

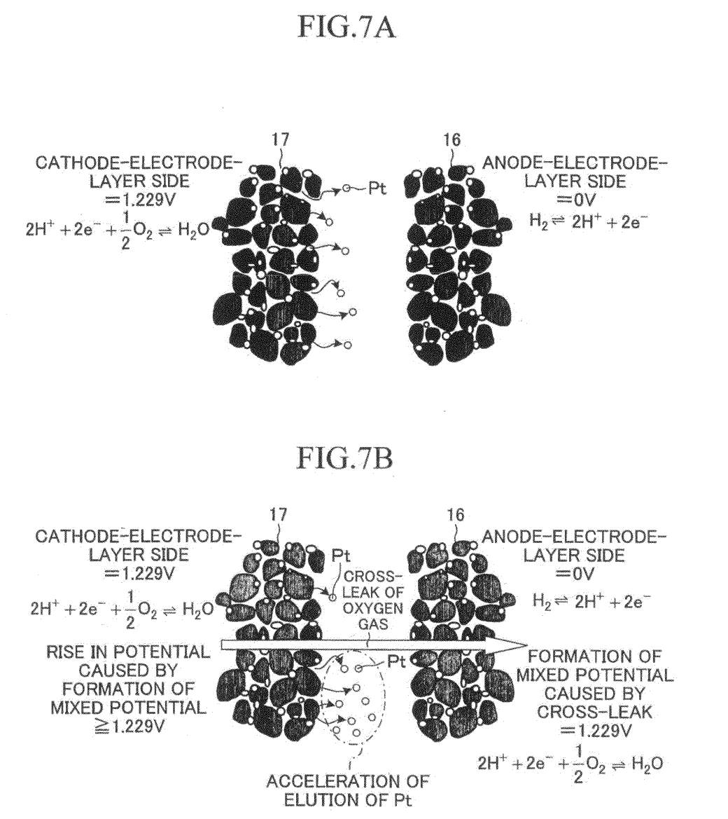

In the MEA 10′ of the comparative structure, electrode potentials associated with electrode reactions on the anode-electrode-layer side and the cathode-electrode-layer side are as shown in FIG. 6. Specifically, an electrode potential is 0 V on the anode-electrode-layer side where the electrode reaction of Reaction Formula 1 occurs, whereas an electrode potential is 1.229 V on the cathode-electrode-layer side where the electrode reaction of Reaction Formula 2 occurs. In this case, when the fuel cell is in a no-load state, each of the anode electrode layer and the cathode electrode layer has a voltage equal to an electrode potential associated with the relevant electrode reaction (hereinafter, the voltage is called an open circuit voltage (OCV)). That is, an open circuit voltage on the anode-electrode-layer side is 0 V, whereas an open circuit voltage on the cathode-electrode-layer side is 1.229 V. Since the open circuit voltage is higher than an elution potential, as shown in FIG. 7A, platinum (Pt) added to the catalyst layer 17 on the cathode-electrode-layer side is eluted preferentially.

In the polymer electrolyte fuel cell, usually, the electrolyte membrane 15 separates hydrogen gas flowing on the anode-electrode-layer side and air (particularly, oxygen gas) flowing on the cathode-electrode-layer side from each other. However, a differential partial pressure between the gases may cause hydrogen gas and oxygen gas to permeate through the electrolyte membrane 15 in mutually opposite directions (so-called cross-leak). In the MEA 10′ of the comparative structure, occurrence of cross-leak may accelerate elution of platinum (Pt) from the catalyst layer 17 on the cathode-electrode-layer side. This will next be described specifically.

When cross-leak occurs across the electrolyte membrane 15, hydrogen gas permeates therethrough from the anode-electrode-layer side toward the cathode-electrode-layer side, and oxygen gas permeates therethrough from the cathode electrode layer toward the anode electrode layer. In this situation, in a region on the cathode-electrode-layer side through which hydrogen gas permeates, permeating hydrogen gas and externally supplied oxygen gas react with each other; in other words, the electrode reaction of Reaction Formula 1 occurs locally on the cathode-electrode-layer side. As mentioned above, an electrode potential associated with the electrode reaction of Reaction Formula 1 (i.e., open circuit voltage) is 0 V. Thus, permeation of hydrogen gas does not cause an increase in electrode potential on the cathode-electrode-layer side.

In a region on the anode-electrode-layer side through which oxygen gas permeates, permeating oxygen gas, dissociated hydrogen ions, and electrons react with one another; in other words, the electrode reaction of Reaction Formula 2 occurs locally on the anode-electrode-layer side. As mentioned above, an electrode potential associated with the electrode reaction of Reaction Formula 2 (i.e., open circuit voltage) is 1.229 V. Thus, permeation of oxygen locally causes an increase in electrode potential on the anode-electrode-layer side. Thus, as shown in FIG. 7B, a mixed potential is locally formed on the anode-electrode-layer side. In a region where the mixed potential is formed, platinum (Pt) becomes likely to be eluted.

However, in the interior of the fuel cell (more specifically, the interior of a single cell), an electrode potential of the cathode electrode layer in relation to an electrode potential of the anode electrode layer (so-called electromotive force) is held constant. Accordingly, at the cathode electrode layer, an electrode potential rises locally in a region corresponding to a region at the anode electrode layer where a mixed potential is formed. More specifically, an electrode potential of the cathode electrode layer rises locally to 1.229 V or higher. Such a rise in electrode potential accelerates elution of platinum (Pt). Therefore, in a state where cross-leak occurs, platinum (Pt) becomes very likely to be eluted from the catalyst layer 17 on the cathode-electrode-layer side. Elution of platinum (Pt) from the catalyst layer 17 hinders progress of the electrode reaction of Reaction Formula 2 at the cathode electrode layer. As a result, efficiency in the fuel cell generating electricity drops greatly.

By contrast, in the MEA 10 according to the present embodiment, even when the fuel cell is in a no-load state, elution of platinum (Pt) from the catalyst layer 13 on the cathode-electrode-layer side can be suppressed greatly. Specifically, through employment of the structure of the MEA 10, the electrode reaction of Reaction Formula 3 occurs on the anode-electrode-layer side, whereas the electrode reaction of Reaction Formula 4 occurs on the cathode-electrode-layer side. As shown in FIG. 6, electrode potentials associated with these electrode reactions (i.e., open circuit voltages) are −0.828 V on the anode-electrode-layer side and 0.401 V on the cathode-electrode-layer side. Electromotive force of the fuel cell is identical with that of the fuel cell which employs the comparative structure.

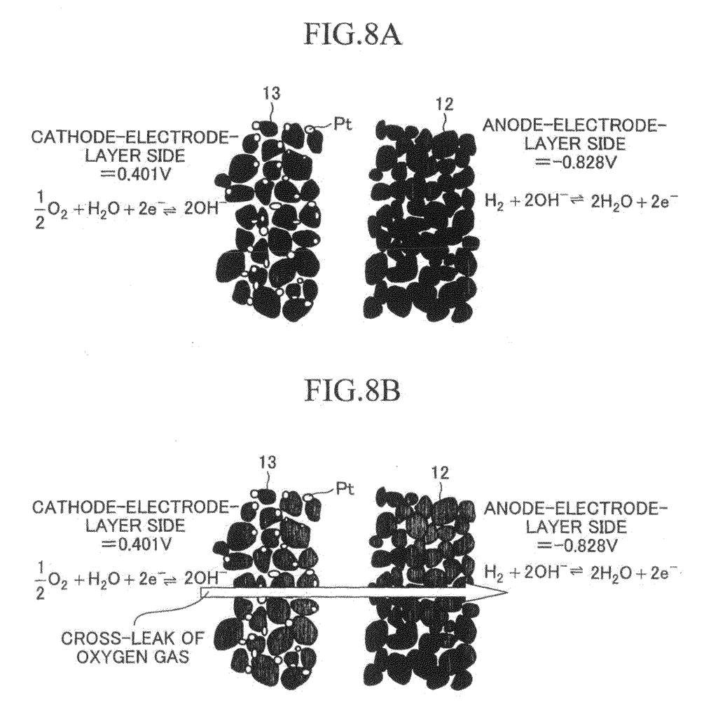

Since an electrode potential at the cathode electrode layer is lower than an elution potential of platinum (Pt), as shown in FIG. 8A, platinum (Pt) is not eluted from the catalyst layer 13. Also, as shown in FIG. 8B, even when cross-leak occurs, the electrode reaction of Reaction Formula 2 does not occur on the anode-electrode-layer side; as a result, a mixed potential is not formed. Accordingly, a local rise in electrode potential does not arise on the cathode-electrode-layer side, and thus elution of platinum (Pt) is not accelerated. Therefore, in the fuel cell which employs the MEA 10 according to the present embodiment, elution of platinum (Pt) from the catalyst layer 13 of the cathode electrode layer is suppressed effectively, so that the fuel cell can maintain good efficiency in generation of electricity over a long term.

As is understood from the above description, through employment of the MEA 10 of the present embodiment, there can be prevented, on the anode-electrode-layer side and on the cathode-electrode-layer side, a drop in efficiency in the fuel cell generating electricity, which could otherwise result from occurrence of a flooding state or occurrence of a dry-up state. Also, since the electrolyte membrane 11 can maintain an appropriate water content, deterioration of the electrolyte membrane 11 (e.g., breakage or an increase in electric resistance) associated with occurrence of a dry-up state can be suppressed, whereby durability of the electrolyte membrane 11 can be improved. Thus, the fuel cell can maintain good efficiency in generation of electricity over a long term.

Regardless of occurrence of a flooding state, the anode electrode layer allows movement of atomic hydrogen (hydrogen ions) in an amount required for electrode reaction. Thus, there can be reduced, for example, variations in output voltage in a state of large load, and a drop in output voltage induced by diffusion polarization which occurs when a large current is output to the exterior of the fuel cell. This can improve electricity-generating performance of the fuel cell.

Since the electrolyte membrane 11 can maintain an appropriate water content, particularly, there is no need to humidify hydrogen gas to be supplied to the anode electrode layer, thereby eliminating the need to carry out troublesome humidification management. Also, since a hydrogen storage alloy can be used to form the catalyst layer 12 which serves as an anode electrode layer, usage of an expensive noble-metal catalyst in the MEA 10 can be reduced. This can greatly reduce the cost of manufacturing the fuel cell.

In the present embodiment, hydroxide ions (anions) move through the electrolyte membrane 11. Thus, a peripheral environment of the MEA 10 becomes alkaline. Since this suppresses corrosion of metal parts such as the separators 20, metal parts plated with nickel, which is inexpensive, can be employed. This also can contribute to a reduction in the cost of manufacturing the fuel cell.

Furthermore, on the anode-electrode-layer side, the separator 20 can be in direct contact with the catalyst layer 12; i.e., metal-to-metal contact can be employed. This can greatly reduce contact resistance, so that electricity can be supplied stably to the exterior of the fuel cell.

According to the present embodiment, the catalyst layer 12 which serves as an anode electrode layer can contain, as a main component, a hydrogen storage alloy selected from among LaNi_{4.5}Al_{0.5}, LaNi_{4.7}Al_{0.3}, and Ti_{1.1}Fe_{0.8}Ni_{0.1}Zr_{0.05}. These hydrogen storage alloys can dissociate externally supplied molecular hydrogen (i.e., hydrogen gas) into atomic hydrogen (i.e., hydrogen ions) and electrons and can absorb (store) dissociated atomic hydrogen and, as needed, desorb molecular hydrogen. Thus, when a peripheral temperature of the MEA 10 is in the high-peripheral-temperature range, the catalyst layer 12 can desorb hydrogen gas required for reaction, and, when a peripheral temperature of the MEA 10 is in the low-peripheral-temperature range, the catalyst layer 12 can absorb (store) hydrogen gas which is supplied and remains unreacted.

Thus, excess hydrogen gas can be retained safely, whereby supplied hydrogen gas is not discharged wastefully and can be consumed effectively. Particularly, when the fuel cell is in an inactive state, there is no need to replace hydrogen gas on the anode-electrode-layer side with inert gas such as nitrogen gas, so that an active state and an inactive state can be switched promptly. Therefore, the fuel cell can provide improved convenience.

Since the electrolyte membrane 11 can be formed of an ion exchange membrane which is selectively permeable to anions, the electrolyte membrane 11 allows anions (i.e., hydroxide ions) formed on the cathode-electrode-layer side to permeate therethrough toward the anode-electrode-layer side. As a result of the electrolyte membrane 11 allowing permeation of hydroxide ions therethrough, the electrode reaction of Reaction Formula 3 occurs on the anode-electrode-layer side, whereas the electrode reaction of Reaction Formula 4 occurs on the cathode-electrode-layer side. This can make an open circuit voltage of the cathode electrode layer lower than an elution potential of platinum (Pt), so that elution of platinum (Pt) from the catalyst layer 13 of the cathode electrode layer can be suppressed effectively. Therefore, deterioration in the catalyst layer 13 can be prevented.

According to the above embodiment, the electrolyte membrane 11 of the MEA 10 is formed of an ion exchange membrane which is selectively permeable to anions. Thus, as represented by Reaction Formula 4, hydroxide ions formed on the cathode electrode layer move toward the anode-electrode-layer side, whereby water is formed in the anode electrode layer. However, as in the case of the above-described comparative structure, in place of the electrolyte membrane 11, the electrolyte membrane 15 formed of an ion exchange membrane (e.g., NAFION (registered trademark of a product of Du Pont)) which is selectively permeable to cations (more specifically, hydrogen ions) can be employed. This modified embodiment will next be described. In the description of the modified embodiment, like parts of the above-described comparative structure and the above embodiment are denoted by like reference numerals, and repeated description thereof is omitted.

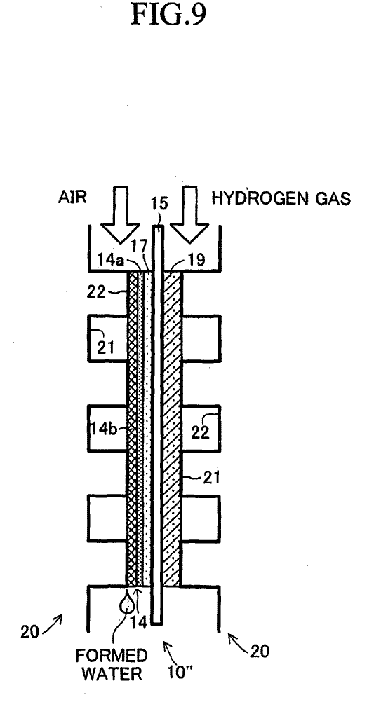

As shown in FIG. 9, an MEA 10″ of the present modified embodiment is configured such that a catalyst layer 19 is bonded to the anode-electrode-layer side of the electrolyte membrane 15. The catalyst layer 19 differs from the catalyst layer 12 of the above embodiment in that metal oxide particles are added so as to enhance hydrophilicity. The catalyst layer 19 is formed in the following manner. In formation of the catalyst layer 19, as described previously, isopropyl alcohol and a predetermined binder are added to a powder of an appropriately selected hydrogen storage alloy. To the resultant mixture are added hydrophilic metal oxide particles, followed by stirring.

After the stirred mixture is applied to, for example, a PTFE sheet, as in the case of the above embodiment, the PTFE sheet and the electrolyte membrane 15 are subjected to hot pressing or the like for joining. The present modified embodiment employs the electrolyte membrane 15 which is selectively permeable to cations. Thus, a peripheral environment of the MEA 10″ becomes acid. Therefore, a hydrogen storage alloy to be selected must have corrosion resistance.

Metal oxide particles to be added are oxide particles of at least a single metal selected as appropriate from, for example, the group consisting of titanium, silicon, aluminum, chromium, magnesium, and zirconium. Since these metal oxide particles have good hydrophilicity, addition of metal oxide particles in a diffused fashion imparts good hydrophilicity to the catalyst layer 19.

The MEA 10″ of the present modified embodiment is configured such that the catalyst layer 17 is bonded to the cathode-electrode-layer side of the electrolyte membrane 15. The catalyst layer 17 is formed in a manner similar to that of the above-described comparative structure. Specifically, the catalyst layer 17 is formed as follows. Carrier carbon is dispersed in water. To the resultant dispersion liquid are added PTFE having water repellency, isopropyl alcohol, and a predetermined binder. The resultant mixture is stirred. The stirred mixture is applied to the water-repellent layer 14a of the gas diffusion layer 14. Subsequently, the gas diffusion layer 14 is superposed on the electrolyte membrane 15 in such a manner that the water-repellent layer 14a faces the electrolyte membrane 15. Then, the resultant laminate is subjected to, for example, hot-pressing, thereby integrally yielding the catalyst layer 17. That is, the cathode electrode layer includes the catalyst layer 17 and the gas diffusion layer 14. Furthermore, as shown in FIG. 9, the present modified embodiment is configured also such that the MEA 10″ is held between the two separators 20.

When gas is supplied to the thus-configured MEA 10″, the electrode reactions of Reaction Formulas 1 and 2 occur on the anode-electrode-layer side and the cathode-electrode-layer side, respectively, of the MEA 10″.

Specifically, on the anode-electrode-layer side, hydrogen gas supplied from the exterior of the fuel cell is dissociated into hydrogen ions and electrons in accordance with Reaction Formula 1 as in the case of the above comparative structure. Dissociated hydrogen ions (i.e., cations) diffuse, by way of solid phase diffusion, in the interior of the catalyst layer 19 and permeate through the electrolyte membrane 15 toward the cathode electrode layer. On the cathode-electrode-layer side, the reaction as expressed by Reaction Formula 2 occurs; i.e., water is formed from oxygen contained in externally supplied air, hydrogen ions which have permeated through the electrolyte membrane 15, and electrons.

In this manner, in the present modified embodiment, water is formed on the cathode-electrode-layer side. Thus, in order to prevent occurrence of a dry-up state on the anode-electrode-layer side, hydrogen gas, together with humidifying water, is supplied to the anode electrode layer.

The catalyst layer 19 on the anode-electrode-layer side is formed from a hydrogen storage alloy. Accordingly, on the anode-electrode-layer side, for example, even when a large amount of excess water is formed as a result of condensation of humidifying water; in other words, even when a flooding state arises, the catalyst layer 19 allows movement of hydrogen ions in an amount required for reaction on the cathode-electrode-layer side.

Metal oxide particles having hydrophilicity are added to the catalyst layer 19. Since this imparts good hydrophilicity to the catalyst layer 19, the catalyst layer 19 absorbs humidifying water which is supplied together with hydrogen gas, thereby retaining water. Also, for example, when formed water diffuses reversely from the cathode electrode layer to the anode electrode layer, the catalyst layer 19 can also efficiently absorb and retain reversely diffused water.

Thus, for example, even when only hydrogen gas is supplied; i.e., hydrogen gas is supplied without being mixed with humidifying water, occurrence of a dry-up state on the anode-electrode-layer side can be suppressed. In such a case where hydrogen gas is supplied without being mixed with humidifying water, a humidifier can be eliminated from a fuel cell system, thereby freeing the fuel cell system from troublesome humidification management on the anode-electrode-layer side.

Also, in the present modified embodiment, air mixed with humidifying water is supplied to the cathode electrode layer, thereby raising concern about occurrence of a flooding state in the cathode electrode layer. However, by virtue of the fact that the catalyst layer 17 and the gas diffusion layer 14 of the cathode electrode layer have water repellency, and by means of adjusting the amount of humidifying water to be mixed in, occurrence of a flooding state can be suppressed. Accordingly, as in the case of the above embodiment, in the present modified embodiment, there can be prevented a drop in efficiency in the fuel cell generating electricity which could otherwise result from occurrence of a flooding state or occurrence of a dry-up state.

Also, in this case, when the fuel cell is in an active state, the catalyst layer 19 which serves as an anode electrode layer can well desorb atomic hydrogen, and, when the fuel cell is in an inactive state, the catalyst layer 19 can well absorb (store) atomic hydrogen. Therefore, in an inactive state, hydrogen gas can be retained safely, thereby eliminating the need to replace hydrogen gas with nitrogen gas. Also, since release of hydrogen gas from inside the fuel cell which would otherwise accompany the replacement is not involved, hydrogen gas can be utilized effectively.

When the fuel cell is in a no-load state, for example, by means of temporarily shutting off supply of hydrogen gas, a peripheral temperature of the MEA 10″ is brought into the low-peripheral-temperature range, whereby filling hydrogen gas on the anode-electrode-layer side can be absorbed (stored) in the catalyst layer 19. This can suppress, for example, occurrence of the reaction of Reaction Formula 2 on the anode-electrode-layer side as in the above-described comparative structure. Therefore, although the effect of suppression is slightly inferior to that of the above embodiment, elution of platinum (Pt) from the catalyst layer 17 on the cathode-electrode-layer side can be suppressed.

The present invention is not limited to the above embodiment and modified embodiment, but may be embodied in various other forms without departing from the scope of the invention.

For example, in the above embodiment and modified embodiment, the separators 20 assume the form of a stainless steel sheet having the streaky recess portions 21 and the streaky projection portions 22 formed thereon. Instead of this, in order to more efficiently supply fuel gas and oxidizer gas, the separator may be composed of a flat-plate-like separator body for preventing mixed flow of gases, and a gas passageway formation member configured such that a large number of streaky recess portions and streaky projection portions are formed on a material in which a large number of through holes are formed (e.g., an expanded metal in which a large number of meshy through holes are formed, or a punched metal in which a large number of through holes are formed).

Employment of such separators allows uniform supply of externally introduced gas to the catalyst layers 12 and 19 and the gas diffusion layer 14 (i.e., the catalyst layers 13 and 17) via a large number of through holes of the gas passageway formation members. Thus, gas can be supplied efficiently, whereby the fuel cell can exhibit improved efficiency in generation of electricity.

As in the case of the catalyst layer 19 of the above modified embodiment, metal oxide particles can be added to the catalyst layer 12 of the above embodiment. Since this imparts good hydrophilicity to the catalyst layer 12, the electrolyte membrane 11 can maintain a favorable water content at all times and thus can exhibit improved durability.

### INDUSTRIAL APPLICABILITY

The present invention can be applied to the structure of an electrode employed in a polymer electrolyte fuel cell.

1. An electrode structure for a fuel cell generating electricity through reaction between externally supplied fuel gas and oxidizer gas, comprising:
an electrolyte membrane selectively permeable to hydroxide ions;
an anode electrode layer formed on one surface of the electrolyte membrane, dissociating molecular hydrogen contained in externally introduced fuel gas into atomic hydrogen and electrons, wherein the externally introduced fuel gas passed through a metal separator having a function of supplying the fuel gas to the anode electrode layer, and allowing solid-phase diffusion of dissociated atomic hydrogen toward the electrolyte membrane, wherein the anode electrode layer contains, as a main component, a hydrogen storage alloy which absorbs and desorbs atomic hydrogen; and
a cathode electrode layer formed on the other surface of the electrolyte membrane and causing reaction between molecular oxygen contained in externally introduced oxidizer gas and electrons formed through dissociation effected by the anode electrode layer.

2. (canceled)

3. An electrode structure for a fuel cell according to claim 1, wherein metal oxide particles having hydrophilicity are added to the anode electrode layer.

4. An electrode structure for a fuel cell according to claim 3, wherein the metal oxide particles are oxide particles of at least one metal selected from the group consisting of titanium, silicon, aluminum, chromium, magnesium, and zirconium.

5. An electrode structure for a fuel cell according to claim 1, wherein:
the oxidizer gas, together with humidifying water, is introduced into the cathode electrode layer; and
the electrolyte membrane is selectively permeable to hydroxide ions formed through reaction in the cathode electrode layer among the molecular oxygen, the humidifying water, and the electrons.

6. An electrode structure for a fuel cell according to claim 1, wherein the anode electrode layer is formed from a hydrogen storage alloy for suppressing an increase in open circuit voltage on the cathode-electrode-layer side.

7. An electrode structure for a fuel cell according to claim 6, wherein the hydrogen storage alloy used to form the anode electrode layer has a property of desorbing absorbed atomic hydrogen when a peripheral temperature of the anode electrode layer falls within a predetermined operating-temperature range of the fuel cell, and absorbing atomic hydrogen when a peripheral temperature of the anode electrode layer is in the vicinity of room temperature.

8. An electrode structure for a fuel cell according to claim 6, wherein the hydrogen storage alloy is an alloy having at least one composition selected from the group consisting of LaNi_{4.5}Al_{0.5}, LaNi_{4.7}Al_{0.3}, and Ti_{1.1}Fe_{0.8}Ni_{0.1}Zr_{0.05}.

9. An electrode structure for a fuel cell according to claim 7, wherein the hydrogen storage alloy is an alloy having at least one composition selected from the group consisting of LaNi_{4.5}Al_{0.5}, LaNi_{4.7}Al_{0.3}, and Ti_{1.1}Fe_{0.8}Ni_{0.1}Zr_{0.05}.
